(19) United States
(12) Patent Application Publication
(10) Pub. No.: US 2008/0110952 A1
(43) Pub. Date: May 15, 2008

(54) Sheet separation through fluid impact

(76) Inventors: Marvin William Kemmerer, Montour Falls, NY (US); Naiyue Zhou, Wilmington, NC (US)

Correspondence Address: CORNING INCORPORATED, SP-TI-3-1, CORNING, NY, 14831, US

(21) Appl. No.: 11/599,929

(22) Filed: Nov. 15, 2006

(51) Int. Cl. C03B 33/02; B26F 3/00

(52) U.S. Cl. 225/2; 225/93

(57) ABSTRACT

A sheet of brittle material, such as glass, flat or bowed, is separated along a score line by applying fluid energy (compressed gas or liquid) through a fluid applicator such as a nozzle or directional fluid motivator, into a scored sheet material. A separation time of less than 1 second is possible with smooth edge quality. The brittle material can be in the form of a moving ribbon of glass sheet or a stationary sheet. A load (tension) can be applied transverse to the score line to enhance crack propagation along the score line. A controller controls the fluid pressure, release time and other process parameters for best results, depending on material properties and structure.

### BACKGROUND OF THE INVENTION

1. Field of the Invention

The present application relates to the separation of a sheet of brittle material through fluid impact, and more particularly, to crack initiation and propagation along a score line in response to the application of fluid energy applied to the brittle material.

2. Description of Related Art

Two methods are conventionally employed for cutting or shaping a sheet of brittle material, such as a glass, amorphous glass, glass-ceramic or ceramic material, to form a piece with a desired configuration or geometry. The two methods include a mechanical-based method and a thermal-based method (e.g., laser).

The first conventional method involves mechanical scribing of the sheet by a hard device (such as a diamond or tungsten tip) to score the surface of the brittle material, which is then broken along the score line in response to a significant bending moment applied to the material. The sheet is generally bowed out-of-plane in both the horizontal and vertical (traveling) directions due to stress distribution inside the sheet. Typically, the bending moment is applied by physically bending the brittle material about the score line. However, the amount of bending movement and amount of movement of the sheet must be carefully controlled since bending can result in multiple break origins along the score line and can even result in crack out (i.e., cracks extending away from the score line). With large sheets, the degree of bow tends to increase, making the bending separation more difficult and uncontrollable. Bending also creates disturbances to the sheet shape (due to its bowed shape), with the bending process causing flattening of the sheet during the bending, and then releasing the sheet after separation. This potentially contributes significantly to sheet stress. Under worst case, bending separation will not work if the sheet bow is too high. In addition, bending separation provides an opportunity for edge rubbing to take place (especially in sheets with greater bows), which generates chips along the edges.

The second conventional technique involves laser scribing, such as described in U.S. Pat. No. 5,776,220. Typical laser scribing includes heating a localized zone of the brittle material with a continuous wave laser, and then immediately quenching the heated zone by applying the coolant, such as a gas, or a liquid such as water. The separation of laser scribed material can be achieved either by mechanical breaking using bending as with the mechanical scribing, or by a second higher energy laser beam. The use of the second higher energy laser beam allows for separation without bending. However, the separation is slow and often it is difficult to control crack propagation. The second laser beam also creates thermal checks and introduces high residual stress.

Notably, physical/mechanical contact with the sheet, such as tapping the sheet along a score line with a hard, sharp probe to promote a crack and separation, carries some risk of damage and/or chipping to the glass sheet. Further, after crack separation, there is a risk of the two newly-formed edges rubbing together and causing edge damage, such as chipping.

Therefore, the need exists for the fast, repeatable and uniform separation that allows minimized bending of a sheet of brittle material, and that minimizes manipulation of the sheet and that minimizes physical contact of a hard object with the glass sheet. The need also exists for a minimized disturbance separation that can be used during vertical forming process (on the draw) or during horizontal forming (e.g., float glass). The need also exists for reducing the twist-hackle distortion commonly associated with aggressive bend induced separation, and improve separation edge quality. The need exists for the consistent separation of a brittle material along a score line, without requiring physical bending of the material, or the introduction of extreme temperature gradients. There is a particular need for the separation of a pane from a continuously moving ribbon of brittle material within very short period of time (less than 1 second), while reducing imparted disturbances which can propagate upstream along the ribbon.

Accordingly, an apparatus and method are desired solving the aforementioned problems and having the aforementioned advantages.

### SUMMARY OF THE INVENTION

The present invention provides for the fast separation of a brittle material through application of fluid (e.g., water, air) to a score line without requiring application of a bending moment and without the need for contacting the glass sheet with a hard or sharp probe, through impact loading without generating significant shear motion. The present system also provides for the fast, repeatable and uniform separation of a pane of brittle material from a continuously moving ribbon of the brittle material, while reducing the introduction of disturbances into the ribbon. The present system further allows for a separation of a sheet of brittle material which reduces twist-hackle commonly observed in aggressive bending moment induced separation, and therefore improve edge quality and reduce glass particle caused by separation. The present system can be used for separating a stationary, independent or fixed sheet of material. However, particular applicability has been found for separating a pane from a ribbon of material, and further applicability has been found for separating a pane of glass from a moving ribbon of glass.

In one aspect of the present invention, a method of separating a sheet of brittle material includes directing an energized stream of fluid against the sheet along the score line with sufficient fluid energy to initiate and propagate a crack along the score line.

In yet another aspect of the present invention, an apparatus for separating a sheet having a score line includes a fluid application device having a nozzle supported and positioned to direct energized/compressed fluid at the sheet along the score line for crack initiation and propagation along the score line.

An object of the present invention is to separate a brittle sheet, such as glass, by a single burst of air, as part of a clean and repeatable process.

Additional features and advantages of the invention are set forth in the detailed description which follows, and will be readily apparent to those skilled in the art from that description or recognized by practicing the invention as described herein. For purposes of description, the following discussion is set forth in terms of glass manufacturing. However, it is understood the invention as defined and set forth in the appended claims is not so limited, except for those claims which specify the brittle material is glass.

It is to be understood that both the foregoing general description and the following detailed description are merely exemplary of the invention, and are intended to provide an overview or framework for understanding the nature and character of the invention as claimed below. Also, the above listed aspects of the invention, as well as the preferred and other embodiments of the invention discussed and claimed below, can be used separately or in any and all combinations.

The accompanying drawings are included to provide a further understanding of the invention, and are incorporated in and constitute a part of this specification. The drawings illustrate various embodiments of the invention, and together with the description serve to explain the principles and operation of the invention. It should be noted that the various features illustrated in the figures are not necessarily drawn to scale. In fact, the dimensions may be arbitrarily increased or decreased for clarity of discussion.

### DESCRIPTION OF THE DRAWINGS

FIGS. 1 and 2 are a perspective schematic view and a front view showing an apparatus for forming a ribbon of brittle material.

FIG. 3 is an enlarged view of an edge of the ribbon.

FIG. 4 is a front elevational schematic view of modified stationary apparatus.

### DETAILED DESCRIPTION OF EMBODIMENTS

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention can be practiced in other embodiments that depart from the specific details disclosed herein. Moreover, descriptions of well-known devices, methods and materials may be omitted so as not to obscure the description of the present invention.

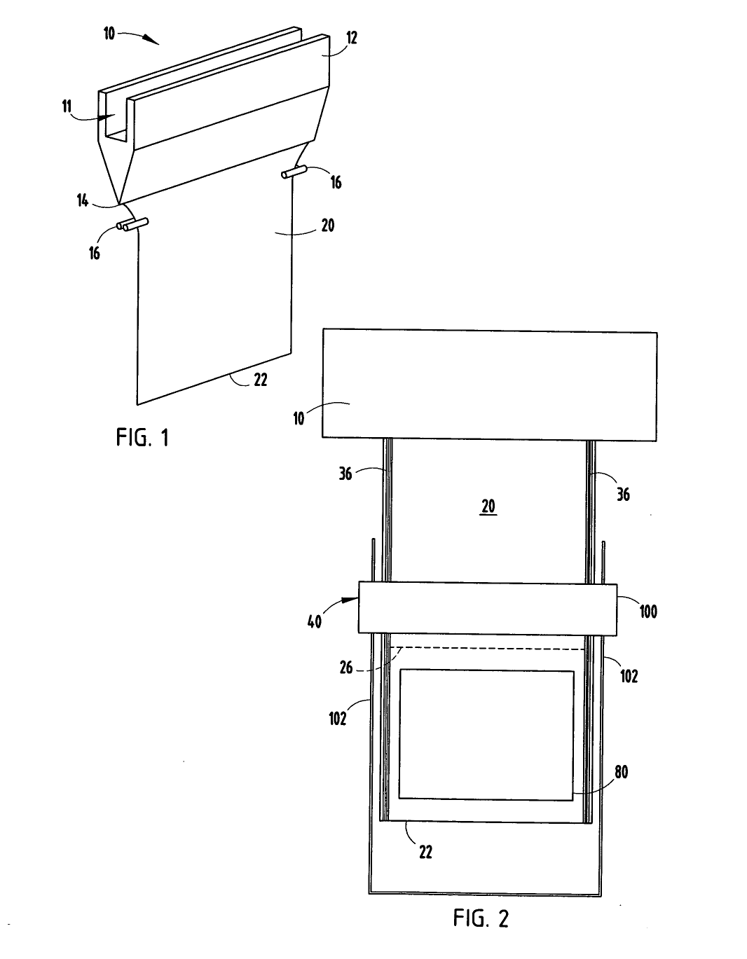

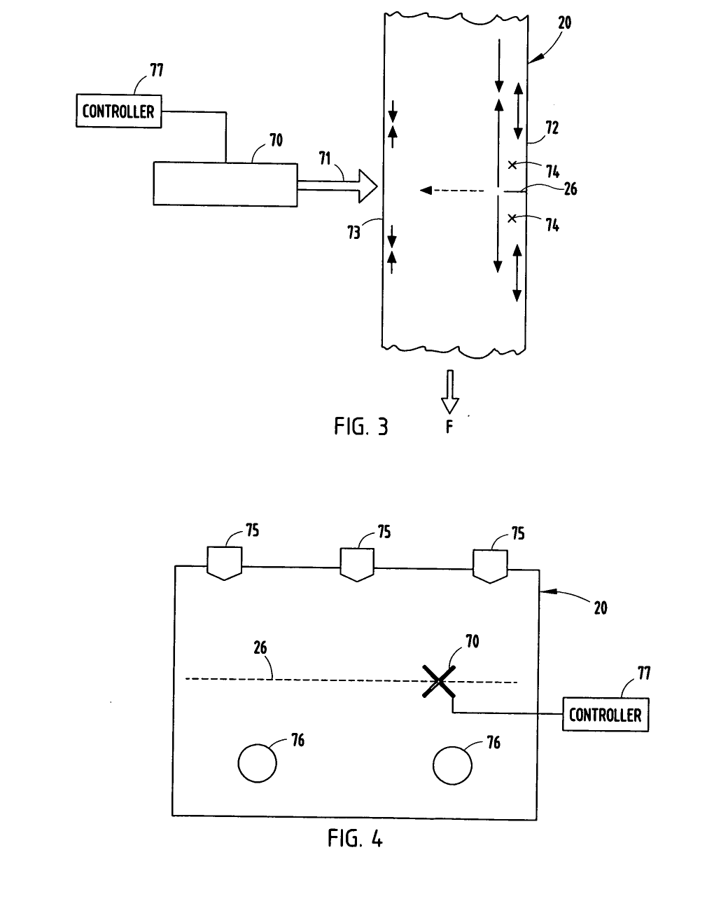

The present apparatus and method provides for the impact induced separation of a brittle material without requiring gross bending of the brittle material. The present apparatus and method further avoids using a single high force blow with a hard object to cause crack propagation. The present apparatus and method also provides a way to control separation time and edge quality. In one configuration (see FIGS. 1-2), the present invention provides for the separation of a pane of a brittle material from a moving ribbon of the material, without introduction of disturbances which can propagate upstream in the ribbon. In another configuration (see FIG. 4), a glass sheet was cut into smaller sized sheets in a static/stationary batch-type operation. For purposes of description, the apparatus of FIG. 3 is initially set forth as separating a glass pane from a moving ribbon of glass.

FIG. 1 is a schematic diagram of glass fabrication apparatus 10 of the type typically used in the fusion process. The apparatus 10 includes a forming isopipe 12, which receives molten glass (not shown) in a cavity 11. The molten glass flows over the upper edges of the cavity 11 and descends along the outer sides of the isopipe 12 to a root 14 to form the ribbon of glass 20. The ribbon of glass 20, after leaving the root 14, traverses fixed edge rollers 16 which engage bulbous edge portions 36 of the glass sheet 20. The ribbon 20 of brittle material is thus formed and has a length extending from the root 14 to a terminal free end 22. Such draw down sheet or fusion processes, are described in U.S. Pat. No. 3,338,696 (Dockerty) and U.S. Pat. No. 3,682,609 (Dockerty), and herein incorporated by reference. It is noted, however, that other types of glass fabrication apparatus can be used in conjunction with the invention, such as laminated down draw, slot draw and laminated fusion processes, as well as horizontal and float-type glass fabrication apparatus.

As the glass ribbon 20 travels down from the isopipe 12, the ribbon changes from a supple, for example 50 millimeter thick liquid form at the root 14, to a stiff glass ribbon of approximately 0.03 mm to 2.0 mm thickness, for example, at the terminal end 22, and having a width of 1000 mm or greater.

A scribing assembly 40 is used to form a score line 26 on the first side 32 of the ribbon 20. The scribing assembly 40 includes a scribe and in certain configurations, a scoring anvil. For purposes of description, the scribe and the scoring anvil are described in terms of travel on a common carriage 100 shown in FIG. 2. The carriage 100 can be movable relative to a frame 102, wherein the movement of the carriage can be imparted by any of a variety of mechanism including mechanical or electromechanical, such as motors, gears, rack and pinion, to match the velocity vector of the ribbon 20. A load assembly 80 loads the glass sheet to facilitate and accelerate separation through faster crack propagation. Loads can be varied as desired for optimal results, eg., 2 pounds to 80 pounds. Preferably, the loads are at least about 0.2 lb/in (i.e., about 10 pounds per 1300 mm wide sheet) or higher such as 25-80 pounds force to assist in obtaining quick separation, such as less than 1 second or even 0.5 seconds.

As shown in FIG. 3, fluid application device 70 is used to compress fluid and direct a stream of fluid under pressure against the unscored side of the glass sheet in alignment with the score line 76. The stream is applied to the glass as a single burst of energized fluid, and when the air is used, is very clean and efficient. The application device 70 can be mounted on the carriage 100 or on a similar device therebelow, with the carriage 100, scribing assembly 40, and the fluid application device 70 being controlled by a controller 77. The application device 70 is configured to suddenly release compressed/pressured fluid 71 towards the scored glass sheet 20 from the non-score side.

A preferred profile of the nozzle of the application device is generally a narrow rectangular slot with length parallel to the score line, although other profiles, such as a circle or oval, can be used. Notably, the length/width ratio affects the separation. The recommended range for the disclosed nozzle is between 10 and 20, and more preferably is between 15-20, with a higher ratio being generally better. Nonetheless, if the ratio is too high, it can divert the compressed fluid too much to initiate the crack. A slot length from 2″ to 6″ and a width from 0.125″ to 0.25″ were successfully used to cause an acceptably fast separation of less than 1 second in a sheet width of 1300 mm and sheet thickness of 0.7 mm. The distance between the nozzle and glass surface may be another significant parameter affecting separation. If the nozzle is too close, it can cause edge damage and sheet vibration after separation. If the nozzle is too far away, separation may not happen. However, a preferred distance may vary depending on operating parameters, the type and thickness of the glass, and related factors. In any case, edge guides or edge restraining devices are recommended to prevent a separated edge from freely moving and also from abrading an adjacent edge. It may be important that an initial burst of fluid be provided for effective separation. It is contemplated that the emitted stream could be sufficient to cause a shock wave.

As the fluid 71 hits the surface of the glass sheet 20, a dynamic localized load is applied onto the contact area, as generally illustrated by the arrows in FIG. 3. The resultant stress in the neighborhood of the impact area is tensile at location 74 near the score line side surface 72 and compressive at the impact side surface 73, as schematically illustrated in FIG. 3. The local stress leads to concentrated tensile stress at the crack tip (2-D) or the crack front (3-D). The crack propagates through the thickness of sheet and mode 1 fracture occurs when the dynamic bending stress is greater than a critical value, which results in a dynamic stress intensity factor exceeding the critical stress intensity factor in the glass sheet. The crack propagation along the score line is aided by the vibration induced by the fluid impact. High speed video process analysis clearly shows the separation of sheet without obvious visible lateral sheet motion and bending.

The stress intensity factor is generally a function of the structure and crack geometries, the applied bending stress, and the crack size. The illustrated application device ejects a stream of fluid 71 against the glass sheet 20 on a side opposite the score line 26 as the application device 70 is moved along the score line 26, with the stream 71 having a narrow width in a direction perpendicular to the score line and potentially a slightly wider shape in a direction along the score line. It is contemplated that the fluid pressure, the duration of application, and the location and distance of device 70 may be varied along the width of the sheet 20 and/or the stream 71 may be pulsed to create optimal crack-initiating characteristics. It is contemplated that the present arrangement works best if the impact is on the opposite side of the score line because tensile stress is induced at the score line side while compressive stress is produced on the other side. It is also contemplated that tensioning the sheet makes the transition of the impact energy more efficient and therefore helps the separation.

By way of example, when the fluid 71 is a gas, such as air, a pressure of about 300 psi flowing through a nozzle opening of about 3/16″×5″ (or 1″ diameter) works well to separate glass sheet. Advantageously, gas, such as air, provides for a very clean separation process. When the fluid 71 is a liquid such as water, a pressure of about 500 psi flowing through a nozzle opening of about 1/16×4″ (or 3/16″ diameter) will work well to separate glass sheet.

FIG. 4 shows a schematic presentation of a batch process for cutting a glass sheet 20 such as for cutting a larger sheet into smaller sheets. Glass sheet 20 is held vertically by three clamps 75 from the top. Vacuum cups 76 at the bottom apply downward force to the sheet. After scoring, a pneumatic fluid application device 70 strikes the glass sheet 20 with compressed fluid, such as air, for a very short period of time from the non-scored glass side. The applicator device 70 is moved along the score line 26 to cause separation. The process/equipment variables affecting the separation can be controlled by a controller 77 operably connected to the fluid application device. The process/equipment variable include: the fluid pressure, release time, orifice profile, distance from the device to the glass surface, application location, fluid temperature and viscosity, and the downward force on the sheet. It is contemplated that these will be optimally controlled for best results in the separation process. Initial test using compressed air yielded promising results, since separation was consistent and instantaneous (less than one second) for a sheet 1300 mm wide. Initial fracture edge analysis demonstrated a pattern similar to that of other known separation processes, but there were no contact area damages.

While the invention has been described in conjunction with specific exemplary embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A method of separating a sheet of brittle material having a score line, the method comprising steps of:
directing an energized stream of fluid against the sheet along the score line with sufficient fluid energy to initiate and propagate a crack along the score line.

2. The method of claim 1, including a step of compressing the fluid.

3. The method of claim 1, including a step of providing a nozzle on an application device defining a narrow slot with length extending parallel to the score line, and wherein the step of directing includes motivating the stream through the slot.

4. The method of claim 3, wherein the slot has a length to width ratio of at least about 10 to 20.

5. The method of claim 4, wherein the step of directing the stream of fluid includes moving the nozzle along the score line to cause the crack to propagate.

6. The method of claim 4, wherein the step of directing the stream of fluid includes not moving the stream along the score line.

7. The method of claim 1, wherein the step of directing the stream of fluid includes providing a gas as the fluid.

8. The method defined in claim 7, wherein the step of directing the stream of fluid includes motivating the fluid at a pressure of at least about 300 psi.

9. The method defined in claim 1, wherein the step of directing the stream of fluid includes motivating a liquid under pressure.

10. The method defined in claim 9, wherein the step of directing the stream of fluid includes motivating the liquid at a pressure of at least 500 psi.

11. The method defined in claim 1, wherein the step of directing the stream of fluid includes motivating the liquid through a nozzle opening size having a width of less than about 0.25 inches, the width being in a direction perpendicular to a length of the score line.

12. The method defined in claim 1, wherein the step of directing the stream of fluid includes providing a fluid application device constructed to emit a fluid under pressure in a stream focused against the unscored side of the sheet in alignment with the score line.

13. The method defined in claim 1, including a controller operably connected to a fluid application device, the fluid application device being configured to direct the energized stream, and including a step of controlling the fluid application device using the controller to control the fluid pressure and release time.

14. The method defined in claim 1, including applying tension to the sheet in a direction perpendicular to the score line.

15. The method defined in claim 1, including applying a tension to the sheet transverse to a length of the score line.

16. The method defined in claim 15, wherein the step of applying the tension includes applying a force of at least about 0.01 pounds/mm of sheet width.

17. An apparatus for separating a sheet having a score line, comprising:
a fluid application device having a nozzle oriented and positioned to motivate energized fluid against the sheet to thus use fluid energy for crack initiation and propagation along the score line.

18. The apparatus defined in claim 17, wherein the nozzle defines an outlet opening that is elongated in a direction parallel the score line.

19. The apparatus defined in claim 18, wherein the opening is elongated to have a length to width ratio of about 10-20.

20. The apparatus defined in claim 18, wherein the opening defines a rectangular slot.

21. The apparatus defined in claim 17, including a controller operably connected to the fluid application device for controlling the applicator device.

22. The apparatus defined in claim 17, wherein the fluid application device is configured to motivate gas under pressure against the sheet.

23. The apparatus defined in claim 17, including a carrier movably supporting the fluid application device.
